(19) United States
(12) Patent Application Publication
(10) Pub. No.: US 2023/0323158 A1
(43) Pub. Date: Oct. 12, 2023

(54) DUAL ADDITIVE POLISHING COMPOSITION FOR GLASS SUBSTRATES

(71) Applicant: CMC Materials, Inc., Aurora, IL (US)

(72) Inventor: Tong LI, Singapore (SG)

(21) Appl. No.: 18/110,633

(22) Filed: Feb. 16, 2023

Related U.S. Application Data
(60) Provisional application No. 63/323,192, filed on Mar. 24, 2022.

(51) Int. Cl. C09G 1/02; C09K 3/14; B24B 37/04

(52) U.S. Cl. CPC C09G 1/02; B24B 37/044; C09K 3/1409

(57) ABSTRACT

A chemical mechanical polishing composition comprises, consists of, or consists essentially of a liquid carrier, abrasive particles in the liquid carrier, a pyrophosphate compound, and a sulfonate compound or a compound including a quaternary ammonium group.

### FIELD OF THE INVENTION

The disclosed embodiments relate to chemical mechanical polishing compositions for polishing glass substrates and more particularly to compositions including a pyrophosphate compound and a sulfonate compound or a quaternary amine.

### BACKGROUND OF THE INVENTION

There is a continued demand for increased storage capacity and miniaturization in the hard disk drive industry. This results in a corresponding demand for smaller memory or rigid disks that have an increased storage (or data) density and a need for improved processes for polishing such memory or rigid disks.

As used herein the term “memory or rigid disk” refers to any magnetic disk, hard disk, rigid disk, or memory disk used for retaining information in electromagnetic form. These memory or rigid disks are referred to in shorthand herein as simply disks or substrates and are generally one of two types: (i) nickel-phosphorus plated aluminum disks or (ii) glass disks. During manufacture the disks are polished to strict surface finish tolerances prior to depositing the magnetic material that is ultimately used for data storage.

As is well known, the data storage industry is subject to continuing and sometimes extreme downward pricing pressure. In order to maintain economically favorable processes, high throughput is commonly required thereby necessitating high material removal rates during a polishing operation. However, increasing removal rates result in increased surface roughness or surface waviness.

While chemical-mechanical polishing (CMP) compositions and methods are commercially available for polishing nickel phosphorus and/or glass disks, there is an unmet demand for improved polishing compositions to improve throughput and enable increased storage density. In particular, there is an unmet demand for polishing compositions that achieve improved surface finish (e.g., reduced surface roughness and surface waviness) and high material removal rates.

### BRIEF SUMMARY OF THE INVENTION

A chemical mechanical polishing composition is disclosed. The composition comprises, consists of, or consists essentially of a liquid carrier, abrasive particles in the liquid carrier, a pyrophosphate compound, and a sulfonate compound including a sulfonate anionic surfactant or a polysulfonic acid.

In another embodiment, a disclosed polishing composition comprises, consists of, or consists essentially of a liquid carrier; abrasive particles in the liquid carrier; a pyrophosphate compound; and a cationic compound including a quaternary ammonium cation.

### DETAILED DESCRIPTION OF THE INVENTION

Chemical mechanical polishing compositions are disclosed. The compositions comprise, consist of, or consist essentially of a liquid carrier, abrasive particles in the liquid carrier, a pyrophosphate compound, and a sulfonate anionic surfactant or an anionic polymer including sulfonic acid groups or a compound including a quaternary ammonium group. In particular embodiments, the compositions comprise, consist of, or consist essentially of a liquid carrier, abrasive particles in the liquid carrier, and a synergistic combination of a pyrophosphate compound and a sulfonate anionic surfactant or an anionic polymer including sulfonic acid groups or a synergistic combination of a pyrophosphate compound and a compound including a quaternary ammonium group.

While the disclosed embodiments are not limited in this regard, the disclosed compositions may be advantageously used to polish glass substrates such as those used for constructing memory or rigid disks in hard disk drives. As described in more detail below by way of the examples, the disclosed polishing compositions include a synergistic combination of chemical additives and have been found to advantageously provide significantly improved polishing rates. Certain ones of the disclosed embodiments have also been found to provide a comparable or even improved surface finish (e.g., surface waviness).

It will be understood that the term “synergistic” (or synergism) is used in accordance with the standard dictionary definition of the term. Synergism is defined as an interaction of elements such that their combined effect is greater than the sum of their individual effects (Dictionary of Science and Technology, Academic Press, 1992). In the disclosed embodiments the combination of a pyrophosphate compound and a sulfonate compound (e.g., a disulfonate anionic surfactant) or a quaternary ammonium compound has been found to increase the removal rate of glass substrate polishing to an extent greater than the sum of the individual contributions of the pyrophosphate compound and the sulfonate compound. Moreover, as described in more detail below in the Examples, the addition of a sulfonate compound or a quaternary ammonium compound to a composition including a pyrophosphate compound was unexpectedly found to increase the removal rate (as opposed to decreasing the removal rate as would be expected).

The disclosed polishing compositions generally contain abrasive particles dispersed or suspended in a liquid carrier. The liquid carrier is used to facilitate the application of the abrasive particles and the chemical additives to the surface of the substrate to be polished. The liquid carrier may include any suitable carrier (e.g., a solvent) including lower alcohols (e.g., methanol, ethanol, etc.), ethers (e.g., dioxane, tetrahydrofuran, etc.), water, and mixtures thereof. The liquid carrier preferably consists of, or consists essentially of, deionized water.

The disclosed polishing compositions include abrasive particles in the liquid carrier, for example, dispersed or suspended in the liquid carrier. The abrasive particles may include substantially any suitable abrasive particles for polishing glass substrates, such as metal oxide particles, diamond particles, and/or ceramic particles. Metal oxide particles may include, for example, silica, ceria, and/or alumina abrasive particles including colloidal and/or fumed metal oxide particles. Ceramic particles may include materials such as cubic boron nitride or silicon carbide.

Preferred embodiments include silica abrasive particles such fumed or colloidal silica abrasive particles. As used herein the term colloidal silica particles refers to silica particles that are prepared via a wet process. Colloidal silica may be precipitated or condensation-polymerized silica, which may be prepared using any method known to those of ordinary skill in the art, such as by the sol gel method or by silicate ion-exchange. Condensation-polymerized silica particles are often prepared by condensing Si(OH)₄ to form substantially spherical particles. Fumed silica is obtained by a pyrogenic or flame hydrolysis process in which silicon tetrachloride is reacted with oxygen in a flame and generally has an aggregate structure in which approximately spherical primary particles are fused together into chain-like aggregates.

The abrasive particles (e.g., colloidal silica particles) may have substantially any suitable particle size. The particle size of a particle suspended in a liquid carrier may be defined in the industry using various means. For example, the particle size may be defined as the diameter of the smallest sphere that encompasses the particle and may be measured using a number of commercially available instruments, for example, including the CPS Disc Centrifuge, Model DC24000HR (available from CPS Instruments, Prairieville, Louisiana) or the Zetasizer® available from Malvern Instruments®. The abrasive particles may have an average particle size of about 5 nm or more (e.g., about 10 nm or more, about 15 nm or more, or about 20 nm or more). The abrasive particles may have an average particle size of about 100 nm or less (e.g., about 50 nm or less, about 45 nm or less, or about 40 nm or less). Accordingly, the colloidal silica particles may have an average particle size in a range from about 5 nm to about 50 nm (e.g., from about 10 nm to about 40 nm, from about 15 nm to about 40 nm, or from about 20 nm to about 40 nm). For example, in one advantageous embodiment the abrasive particles comprise colloidal silica having a mean particle size of about 30 nm.

The polishing composition may include substantially any suitable amount of the above described abrasive particles. For example, the polishing composition may include about 1 wt. % or more abrasive particles at point of use (e.g., about 2 wt. % or more, about 3 wt. % or more, or about 5 wt. % or more). The amount of abrasive particles in the polishing composition may include about 20 wt. % or less at point of use (e.g., about 15 wt. % or less, about 12 wt. % or less, or about 10 wt. % or less). Accordingly, it will be understood that the amount of abrasive particles may be in a range bounded by any two of the aforementioned endpoints, for example, in a range from about 1 wt. % to about 20 wt. % at point of use (e.g., from about 2 wt. % to about 20 wt. %, from about 5 wt. % to about 15 wt. %, from about 5 wt. % to about 12 wt. %, or from about 5 wt. % to about 10 wt. %). For example, in one advantageous embodiment the polishing composition may include about 8.5 wt. % colloidal silica at point of use.

The disclosed polishing composition further comprises a pyrophosphate compound. As used herein the term pyrophosphate compound refers to a compound that includes phosphorus oxyanions that contain two phosphorus atoms in a P—O—P linkage. It will be appreciated that pyrophosphate compounds are commonly referred to in the chemical arts as diphosphates or diphosphate compounds (presumably because the phosphorus oxyanion includes two phosphorus atoms). The disclosed embodiments may include substantially any suitable pyrophosphate compound, for example, including disodium pyrophosphate (DSPP), tetrasodium pyrophosphate (TSPP), dipotassium pyrophosphate (DKPP), and tetrapotassium pyrophosphate (TKPP). Preferred pyrophosphate compounds include TSPP and TKPP.

The polishing composition may include substantially any suitable amount of the above described pyrophosphate compound. For example, the polishing composition may include about 0.001 wt. % (10 ppm by weight) or more pyrophosphate compound at point of use (e.g., about 0.01 wt. % or more or about 0.02 wt. % or more). The amount of pyrophosphate compound in the polishing composition may be about 1 wt. % or less at point of use (e.g., about 0.5 wt. % or less, about 0.3 wt. % or less, or about 0.2 wt. % or less). Accordingly, it will be understood that the amount of pyrophosphate compound may be in a range bounded by any two of the aforementioned endpoints, for example, in a range from about 0.001 wt. % to about 1 wt. % at point of use (e.g., from about 0.01 wt. % to about 0.5 wt. %, from about 0.01 wt. % to about 0.3 wt. %, from about 0.02 wt. % to about 0.3 wt. %, or from about 0.02 wt. % to about 0.2 wt. %). For example, in certain advantageous embodiments the polishing composition may include about 0.03 wt. %, 0.06 wt. %, 0.08 wt. %, or about 0.12 wt. % TKPP at point of use.

The disclosed polishing composition further includes a second additive compound (in addition to the pyrophosphate compound). The second additive compound may include either (i) a sulfonate compound including a sulfonate anionic surfactant or an anionic polymer including sulfonic acid groups or (ii) a compound including a quaternary ammonium group (also referred to herein as quaternary amine or a quaternary ammonium compound). As described in more detail below in the Examples, the combination of the pyrophosphate compound and the second additive compound may be a synergistic combination that advantageously provides for a significantly increased removal rate during polishing and may also improve the surface finish of the polished substrate.

In certain embodiments the second additive compound may include substantially any suitable sulfonate anionic surfactant or anionic polymer including sulfonic acid groups (a polysulfonic acid). For example, suitable subclasses of sulfonate anionic surfactants may include alkylaryl sulfonates (e.g., alkylbenzene sulfonates such as dodecylbenzene sulfonate), alkyl sulfonates (e.g., alkenyl sulfonates such as alpha-olefin sulfonates, alkylglyceride sulfonates, alkylether sulfonates and alkyl sulfoacetates), alkyldiphenyloxide sulfonates, sulfosuccinates (e.g., monoalkyl sulfosuccinates, and dialkyl sulfosuccinates), acyl taurates, and acyl isethionates.

In certain preferred embodiments, the sulfonate anionic surfactant includes a disulfonate anionic surfactant such as an alkyldiphenyloxide disulfonate anionic surfactant having the following structure:

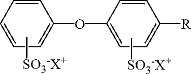

wherein R is a C₁-C₃₀, preferably C₆-C₃₀, more preferably C₆-C₂₂, linear or branched, saturated or unsaturated alkyl group, wherein the alkyl group optionally contains one or more heteroatoms selected from the group consisting of O and N, and wherein X⁺ is H or a cation, e.g., an alkali metal cation or alkaline earth cation (e.g., sodium, potassium, lithium, calcium, magnesium, and the like). Examples of suitable alkyldiphenyloxide disulfonate surfactants include surfactants commercially available from the Dow Chemical Company (Midland, Mich.) under the trade names Dowfax® 2A1, Dowfax® 3B2, Dowfax® 8390, Dowfax® C6L, Dowfax® C10L, and Dowfax® 30599.

Non-limiting examples of polymers or copolymers comprising sulfonic acid groups include polystyrenesulfonic acid, polyvinylsulfonic acid (PVSA), poly(2-acrylamido-2-methylpropane sulfonic acid), poly(styrenesulfonic acid-co-maleic acid), and poly(acrylic acid)-co-poly (2-acrylamido 2-methylpropane sulfonic acid).

In embodiments including a sulfonate anionic surfactant or a polysulfonic acid, the composition may include substantially any suitable amount of the above described second additive compound. For example, the polishing composition may include about 0.001 wt. % (10 ppm by weight) or more of the second additive compound at point of use (e.g., about 0.01 wt. % or more or about 0.02 wt. % or more). The amount of second additive compound in the polishing composition may be about 1 wt. % or less at point of use (e.g., about 0.5 wt. % or less, about 0.3 wt. % or less, or about 0.2 wt. % or less). Accordingly, it will be understood that the amount of second additive compound may be in a range bounded by any two of the aforementioned endpoints, for example, in a range from about 0.001 wt. % to about 1 wt. % at point of use (e.g., from about 0.01 wt. % to about 0.5 wt. %, from about 0.01 wt. % to about 0.3 wt. %, from about 0.02 wt. % to about 0.3 wt. %, or from about 0.02 wt. % to about 0.2 wt. %). For example, in certain advantageous embodiments the polishing composition may include about 0.05 wt. % Dowfax® 2A1, Dowfax® 3B2, Dowfax® C6L, or Dowfax® C10L at point of use.

Disclosed embodiments including a sulfonate anionic surfactant or a polysulfonic acid may further optionally include an anionic (or another anionic) polymer, for example, including poly(acrylic acid) (PAA), poly(methacrylic acid) (PMAA), poly(maleic acid) (PMA), and the like. The use of such a polymer in the polishing composition may advantageously control friction during the polishing operation and may reduce substrate waviness. Such a polymer does not interact synergistically with the pyrophosphate and/or the sulfonate compound. Example compositions may include from about 0 to about 1000 ppm by weight of such an optional anionic polymer (e.g., from about 30 to about 300 ppm by weight of PAA or PMAA in certain embodiments).

It will be understood that the term “sulfonate” as used herein refers to an ionized (anion) form of the surfactant (or polymer), which includes at least one anionic oxygen, as well as to the acid forms of the surfactants, which include at least one acidic OH group. As is well known in the chemical arts, the acid forms of many sulfur-based surfactants generally are highly acidic and will tend to be ionized even at relatively low pH values (e.g., pH 2 to 3). Thus, the anionic surfactants in the CMP compositions of the present invention will generally be present predominately in the anionic form regardless of whether the surfactant was added to the composition in a salt form or acid form.

In certain other embodiments the second additive compound may include substantially any suitable quaternary amine (i.e., substantially any suitable compound including a quaternary ammonium group. Such compounds may be represented by the following chemical formula: --N⁺R′R″R′”wherein R′, R″, and R‴ may be the same or different and may include substantially any carbon containing compound. It will be understood that the n-ium group in the quaternary ammonium may have a structure corresponding to the structure of the tertiary amine as a raw material. For example, if the tertiary amine is triethylamine, the corresponding quaternary ammonium group is triethylammonium. The quaternary ammonium group may be, for example, one having a saturated hydrocarbon group (such as trimethylamine, triethylamine, dimethylethylamine, and the like), a hydroxyl group, an ether group, an amino group, and/or one having a hydrocarbon group containing an unsaturated carbon bond (such as dimethyl ethanolamine, dimethylaniline, diethylaniline, dimethylbenzylamine, pyridine, and the like).

In preferred embodiments, the compound including the quaternary ammonium group comprises a tetramethylammonium group, a tetraethylammonium group, a tetrabutylammonium group, a benzyltributylammonium group, or a mixture thereof. In most preferred embodiments the compound includes tetraethylammonium hydroxide.

In embodiments including a compound having a quaternary ammonium group, the composition may include substantially any suitable amount of the compound. For example, the polishing composition may include about 0.001 wt. % (10 ppm by weight) or more of the compound at point of use (e.g., about 0.01 wt. % or more or about 0.02 wt. % or more). The amount of the compound in the polishing composition may be about 0.5 wt. % or less at point of use (e.g., about 0.4 wt. % or less, about 0.3 wt. % or less, or about 0.2 wt. % or less). Accordingly, it will be understood that the amount of the compound may be in a range bounded by any two of the aforementioned endpoints, for example, in a range from about 0.001 wt. % to about 0.5 wt. % at point of use (e.g., from about 0.01 wt. % to about 0.5 wt. %, from about 0.01 wt. % to about 0.4 wt. %, from about 0.02 wt. % to about 0.3 wt. %, or from about 0.02 wt. % to about 0.2 wt. %). For example, in certain advantageous embodiments the polishing composition may include about 0.02 wt. %, 0.05 wt. %, 0.1 wt. %, or 0.2 wt. % tetraethylammonium hydroxide at point of use.

The disclosed polishing compositions are generally acidic, having a pH of less than about 7. For example, the pH may be greater than about 1 (e.g., greater than about 1.5). The pH may be less than about 5 (e.g., less than about 4, less than about 3.5, or less than about 3). Accordingly, it will be understood that the pH of the polishing composition may be bounded by any of the aforementioned endpoints, for example, in a range from about 1 to about 5 (e.g., from about 1 to about 4, from about 1.5 to about 3.5, or from about 1.5 to about 3). For polishing compositions including a pyrophosphate compound and a sulfonate compound, the pH may most preferably be in a range from about 1.5 to about 2. For polishing compositions including a pyrophosphate compound and a quaternary amine, the pH may most preferably be in a range from about 2 to about 3.

The pH of the polishing composition may be achieved and/or maintained by any suitable means. The polishing composition may include substantially any suitable pH adjusting agents or buffering systems known to those of ordinary skill in the chemical arts. For example, suitable pH adjusting agents may include various acids including nitric acid, sulfuric acid, phosphoric acid, and the like.

Disclosed polishing compositions may include substantially any additional optional chemical additives. For example, the disclosed compositions may further include one or more dispersants and/or biocides. Such additional additives are purely optional. The disclosed embodiments are not so limited and do not require the use of any one or more of such additives. In embodiments further including a biocide, the biocide may include any suitable biocide.

The polishing composition may be prepared using any suitable techniques, many of which are known to those skilled in the art. The polishing composition may be prepared in a batch or continuous process. Generally, the polishing composition may be prepared by combining the components thereof in any order. The term “component” as used herein includes the individual ingredients (e.g., the colloidal silica, the pyrophosphate, and the second additive compound).

For example, the polishing composition components may be added directly to a dispersion including abrasive particles. Alternatively, the abrasive may be added to a solution including the pyrophosphate and the second additive compound. Either way the abrasive particles and the other components may be blended together using any suitable techniques for achieving adequate mixing. Such blending/mixing techniques are well known to those of ordinary skill in the art.

The polishing composition of the invention may also be provided as a concentrate which is intended to be diluted with an appropriate amount of water prior to use. In such an embodiment, the polishing composition concentrate may include the abrasive (e.g., silica), the pyrophosphate compound, the second additive compound, and any other optional compounds in amounts such that, upon dilution of the concentrate with an appropriate amount of water, each component of the polishing composition will be present in the polishing composition in an amount within the appropriate ranges recited above for each component. For example, the colloidal silica and other optional components may each be present in the polishing composition in an amount that is about 2 times (e.g., about 3 times, about 4 times, or about 5 times) greater than the point of use concentrations recited above for each component so that, when the concentrate is diluted with an equal volume of (e.g., 1 equal volume of water, 2 equal volumes of water, 3 equal volumes of water, or 4 equal volumes of water), each component will be present in the polishing composition in an amount within the ranges set forth above for each component. Furthermore, as will be understood by those of ordinary skill in the art, the concentrate may contain an appropriate fraction of the water present in the final polishing composition in order to ensure that other components are at least partially or fully dissolved in the concentrate.

The disclosed polishing compositions may be advantageously used to polish a glass substrate, and preferably a rigid disk glass substrate. The disclosed compositions may be used in conjunction with a polishing machine suitable for polishing glass substrates such as rigid disk glass substrates. Such polishing machines commonly include upper and lower platens and are configured to polish both sides of multiple substrates simultaneously. Polishing pads are mounted on each platen and the platens are generally rotated independently in opposite directions.

During a polishing operation, the substrates are loaded one or more carriers that engage inner and outer gears on the lower platen. The rotation rate of the carriers is controlled by controlling rotation of the gears. The upper platen is lowered into contact with the substrates and the polishing composition is dispensed to the substrates through the upper platen (and the upper pad). The platen and carrier rotation rates are selected so that the upper and lower sides of the substrates are polished at approximately the same rate.

The effectiveness of the polishing process may be characterized in a number of ways, for example, in terms of the polishing removal rate and the surface roughness or surface waviness of the polished substrate. The removal rate may be determined, for example, via measuring weight loss (via weighing the substrate before and after polishing) to determine the amount of substrate removed per unit of polishing time. Surface roughness can be evaluated in terms of average roughness (Ra) or surface waviness (HMS_Wq ) and may be determined, for example, via profilometer or atomic force microscopy (AFM) measurements or via optical measurement techniques using equipment such as the Candela 6100 or 6300 available from KLA Tencor.

The substrates may be polished with the disclosed compositions using any suitable polishing pad. Suitable pads include, for example, woven and non-woven polishing pads. Moreover, suitable polishing pads can comprise any suitable polymer of varying density, hardness, thickness, compressibility, ability to rebound upon compression, and compression modulus. Suitable polymers include, for example, polyvinylchloride, polyvinylfluoride, nylon, fluorocarbon, polycarbonate, polyester, polyacrylate, polyether, polyethylene, polyamide, polyurethane, polystyrene, polypropylene, coformed products thereof, and mixtures thereof.

It will be understood that the disclosure includes numerous embodiments. These embodiments include, but are not limited to the embodiment listed in the claims.

The following examples further illustrate the invention but, of course, should not be construed as in any way limiting its scope.

### Example 1

This example demonstrates the synergistic combination of a pyrophosphate compound and an sulfonate anionic surfactant in the disclosed polishing compositions. Each polishing composition included 8.5 weight percent colloidal silica having a mean particle size of 30 nm and sufficient nitric acid to adjust the pH to 1.8. Polishing composition 1A included no other components. Polishing compositions 1B through 1I further included tetrapotassium pyrophosphate (TKPP) and/or an alkyldiphenyloxide disulfonate anionic surfactant (DOWFAX® C10L) in the amounts indicated in Table 1 (all amounts are in weight percent).

Six separate glass disks (substrates) were polished using each composition (six disks were polished simultaneously in each run) using a Hamai 9B double sided polishing tool for 11 minutes at a lower platen speed of 60 rpm, a carrier rotation rate of 20 rpm, a carrier revolution of 12 rpm, a downforce of 33 g/cm², and a slurry flow rate of 600 ml/min. The polishing rate was determined based on mass loss and the surface waviness (HMS_Wq) was determined for two of the six disks using a Candela 6100 measurement tool. Removal rate and surface waviness results are reported in Table 1. The results are normalized with respect to the removal rate and surface waviness achieved using polishing composition 1A.

TABLE 1

| Polishing Composition | Phosphate Compound | Sulfonate Compound | Removal Rate | Surface Waviness |
|---|---|---|---|---|
| 1A | NA | NA | 100 | 100 |
| 1B | NA | DF C10L (0.02%) | 85 | 76 |
| 1C | NA | DF C10L (0.05%) | 73 | 66 |
| 1D | TKPP (0.02%) | NA | 115 | 110 |
| 1E | TKPP (0.03 %) | NA | 130 | 115 |
| 1F | TKPP (0.08%) | NA | 138 | 115 |
| 1G | TKPP (0.12%) | NA | 152 | 120 |
| 1H | TKPP (0.16%) | NA | 151 | 121 |
| 1I | TKPP (0.08%) | DF C10L (0.05%) | 155 | 107 |

As set forth in Table 1, the addition of the disulfonate surfactant (1B and 1C) to the base composition (1A) improved surface waviness at the expense of reducing the removal rate (waviness was reduced to normalized values of 76 and 66 at the expense of reducing the removal rate from to normalized values of 85 and 73). The addition of pyrophosphate (1D, 1E, 1F, 1G, and 1H) to the base composition (1A) was observed to increase the removal rate at the expense of also increasing surface waviness (the removal rates increased with increasing TKPP concentration to normalized values of 115, 130, 138, 152, and 151 at the expense of also increasing the waviness to normalized values of 110, 115, 115, 120, and 121).

An unexpected synergistic interaction was observed for composition 1H in which the addition of the disulfonate surfactant to the composition including the pyrophosphate compound significantly improved both the removal rate and the surface waviness. Comparing the results for composition 1I to composition 1F, the addition of the disulfonate surfactant increased the removal rate from a normalized value of 138 to 155 and reduced the waviness from a normalized value of 115 to 107. The further improvement in removal rate was both unexpected (as the addition of disulfonate surfactant was observed to decrease removal rate in compositons 1B and 1C) and synergistic. Were the combination of pyrophosphate and disulfonate anionic surfactant merely additive (or less), then a maximum removal rate of 111 would be expected for composition 1I (an increase in 38 plus a decrease in 27 yielding a net increase of 11). The observed removal rate of 155 is therefore clear evidence of synergism.

### Example 2

This example further demonstrates the synergistic combination of a pyrophosphate compound and an anionic sulfonate surfactant in the disclosed polishing compositions and the effect of an optional anionic polymer additive. Each polishing composition included 8.5 weight percent colloidal silica having a mean particle size of 30 nm and sufficient nitric acid to adjust the pH to 1.8. Polishing compositions 1C, 1G, and 1I were described above in Example 1. Polishing compositions 2A through 2G further included TKPP and/or DOWFAX® C10L in the amounts indicated in Table 2 (all amounts are in weight percent). Compositions 2A through 2G still further included 0.01 weight percent (100 ppm by weight) polyacrylic acid having a molecular weight of 250,000 g/mol.

Six separate glass disks (substrates) were polished using each composition using a Hamai 9B double sided polishing tool at the polishing conditions described above in Example 1. The polishing rate and surface waviness HMS_Wq were also determined as described above for Example 1. Removal rate and surface waviness results are reported in Table 2. The results are normalized with respect to the removal rate and surface waviness achieved using polishing composition 1A reported in Table 1.

TABLE 2

| Polishing Composition | Phosphate Compound | Sulfonate Compound | Optional Polymer | Removal Rate | Surface Waviness |
|---|---|---|---|---|---|
| 1C | NA | DF C10L (0.05%) | NA | 73 | 66 |
| 2A | NA | DF C10L (0.05%) | PAA (0.01%) | 72 | 60 |
| 1I | TKPP (0.08%) | DF C10L (0.05%) | NA | 155 | 107 |
| 2B | TKPP (0.08%) | DF C10L (0.05%) | PAA (0.01%) | 154 | 102 |
| 1G | TKPP (0.12%) | NA | NA | 152 | 120 |
| 2C | TKPP (0.12%) | DF C10L (0.01%) | PAA (0.01%) | 156 | 117 |
| 2D | TKPP (0.12%) | DF C10L (0.03%) | PAA (0.01%) | 163 | 109 |
| 2E | TKPP (0.12%) | DF C10L (0.05%) | PAA (0.01%) | 174 | 106 |
| 2F | TKPP (0.12%) | DF C10L (0.085%) | PAA (0.01%) | 185 | 102 |
| 2G | TKPP (0.12%) | DF C10L (0.12%) | PAA (0.01%) | 170 | 110 |

As set forth in Table 2, the addition of PAA was observed to reduce surface waviness and removal rate. In the absence of TKPP, the addition of PAA to a composition including a disulfonate surfactant (comparing compositions 2A to 1C) reduced the removal rate from a normalized value of 73 to 72 and reduced the waviness from a normalized value of 66 to 60. The PAA did not participate in or interfere with the synergism between the pyrophosphate compound and the disulfonate surfactant. In a composition including a synergistic combination of TKPP and disulfonate surfactant the addition of PAA (comparing compositions 2B and 1I) reduced the removal rate from a normalized value of 155 to 154 and reduced the waviness from a normalized value of 107 to 102.

A synergistic interaction between the pyrophosphate compound and the disulfonate surfactant was further observed in compositions 2C-2G in which the addition of the disulfonate surfactant to the composition including TKPP significantly improved both the removal rate and the surface waviness. Comparing compositions 2C-2F to composition 1G the removal rates were observed to increase with increasing concentration of disulfonate surfactant from a normalized value of 152 to normalized values of 156, 163, 174, and 185 and the waviness was observed to decrease from a normalized value of 120 to normalized values of 117, 109, 106, and 102.

### Example 3

This example demonstrates that the above described synergistic interaction was not observed for polishing compositions including other phosphate compounds (in other words the synergistic interaction was only observed for compositions including a pyrophosphate compound). As described above for Example 1, each polishing composition included 8.5 weight percent colloidal silica having a mean particle size of 30 nm and sufficient nitric acid to adjust the pH to 1.8. Polishing compositions 1G and 2E are described above in Examples 1 and 2. Polishing compositions 3A and 3B further included 0.093 weight percent Hydroxyethylidene Diphosphonic Acid (HEDP), compositions 3C and 3D further included 0.259 weight percent diethylenetriamine penta (methylene phosphonic acid) (DTPMPA), compositions 3E and 3F further included 0.122 weight percent 2-Phosphonobutane 1,2,4-tricarboxylic acid (PBTC), and polishing compositions 3G and 3H further included 0.5 weight percent tartaric acid (a carboxylic acid). Note that compositions 1G, 2E, and 3A-3H had the same molar concentration of the phosphate or carboxylic acid additive. Compositions 1G, 3B, 3D, 3F, and 3H further included 0.05 weight percent alkyldiphenyloxide disulfonate surfactant (DOWFAX® C10L). The additive amounts are listed in Table 3.

Six separate glass disks (substrates) were polished using each composition using a Hamai 9B double sided polishing tool at the polishing conditions described above in Example 1. The polishing rate and surface waviness HMS_Wq were also determined as described above for Example 1. Removal rate and surface waviness results are reported in Table 3. The results are normalized with respect to the removal rate and surface waviness achieved using polishing composition 1A reported in Table 1.

TABLE 3

| Polishing Composition | Phosphate Compound | Sulfonate Compound | Removal Rate | Surface Waviness |
|---|---|---|---|---|
| 1G | TKPP (0.12 wt%) | NA | 152 | 120 |
| 2E | TKPP (0.12 wt%) | DF C10L (0.05 wt%) | 174 | 106 |
| 3A | HEDP (0.093 wt%) | NA | 136 | 108 |
| 3B | HEDP (0.093 wt%) | DF C10L (0.05 wt%) | 116 | 95 |
| 3C | DTPMPA (0.259 wt%) | NA | 151 | 107 |
| 3D | DTPMPA (0.259 wt%) | DF C10L (0.05 wt%) | 128 | 101 |
| 3E | PBTC (0.122 wt%) | NA | 181 | 132 |
| 3F | PBTC (0.122 wt%) | DF C10L (0.05 wt%) | 114 | 95 |
| 3G | Tartaric acid (0.5 wt%) | NA | 138 | 116 |
| 3H | Tartaric acid (0.5 wt%) | DF C10L (0.05 wt%) | 129 | 100 |

As set forth in Table 2, the synergistic effect observed above in Examples 1 and 2 was only observed for compositions including a pyrophosphate compound (comparing compositions 1G and 2E as described above in Example 2). No synergism was observed for compositions including the other phosphonate and carboxylic acid additives. The addition of the disulfonate anionic surfactant to a composition including HEDP (comparing 3A and 3B) was observed to reduce the removal rate and the waviness (waviness was reduced from a normalized value of 108 to 95 at the expense of decreasing removal rate from a normalized value of 136 to 116). The addition of the disulfonate anionic surfactant to a composition including DTPMPA (comparing 3C and 3D) was observed to reduce the removal rate and the waviness (waviness was reduced from a normalized value of 107 to 101 at the expense of decreasing the removal rate from a normalized value of 151 to 128). The addition of the disulfonate anionic surfactant to a composition including PBTC (comparing 3E and 3F) was observed to reduce the removal rate and the waviness (waviness was reduced from a normalized value of 132 to 95 at the expense of decreasing the removal rate from a normalized value of 181 to 114). And the addition of the disulfonate anionic surfactant to a composition including tartaric acid (comparing 3G and 3H) was observed to reduce the removal rate and the waviness (waviness was reduced from a normalized value of 116 to 100 at the expense of the decreasing the removal rate from a normalized value of 138 to 129).

### Example 4

This example demonstrates that the above described synergistic effect was observed for polishing compositions using other sulfonated surfactants (in addition to the DOWFAX® C10L used in Examples 1 and 2). As described above for Example 1, each polishing composition included 8.5 weight percent colloidal silica having a mean particle size of 30 nm and sufficient nitric acid to adjust the pH to 1.8. Polishing compositions 1F, 1G, 1I, and 2E are described above in Examples 1 and 2. Polishing compositions 4A-4D and 4F further included 0.12 weight percent TKPP, while composition 4E further included 0.08 weight percent TKPP. Polishing compositions 4A-4F further included 0.05 weight percent dodecylbenzenesulfonate (DDBS) (4A), DOWFAX® C6L (4B), DOWFAX® 3B2 (4C), DOWFAX® 2A1 (4D), polyvinylsulfonic acid (PVSA) (4E), and DEQUEST® P9200 (a modified polyacrylic acid) (4F). These additive amounts are listed in Table 4.

Six separate glass disks (substrates) were polished using each composition using a Hamai 9B double sided polishing tool at the polishing conditions described above in Example 1. The polishing rate and surface waviness HMS_Wq were also determined as described above for Example 1. Removal rate and surface waviness results are reported in Table 4. The results are normalized with respect to the removal rate and surface waviness achieved using polishing composition 1A reported in Table 1.

TABLE 4

| Polishing Composition | Phosphate Compound | Sulfonate Compound | Removal Rate | Surface Waviness |
|---|---|---|---|---|
| 1F | TKPP (0.08%) | NA | 138 | 115 |
| 1G | TKPP (0.12 wt%) | NA | 152 | 120 |
| 1I | TKPP (0.08 wt%) | DF C10L (0.05 wt%) | 155 | 107 |
| 2E | TKPP (0.12 wt%) | DF C10L (0.05 wt%) | 174 | 106 |
| 4A | TKPP (0.12 wt%) | DDBS (0.05 wt%) | 153 | 105 |
| 4B | TKPP (0.12 wt%) | DF C6L (0.05 wt%) | 178 | 109 |
| 4C | TKPP (0.12 wt%) | DF 3B2 (0.05 wt%) | 179 | 110 |
| 4D | TKPP (0.12 wt%) | DF 2A1 (0.05 wt%) | 155 | 115 |
| 4E | TKPP (0.08 wt%) | PVSA (0.05 wt%) | 144 | 110 |
| 4F | TKPP (0.12 wt%) | DQ P9200 (0.005 wt%) | 120 | 108 |

As set forth in Table 4, the synergistic effect observed above in Examples 1 and 2 was also observed for polishing compositions including other sulfonate compounds. The use of other disulfonate anionic surfactants to compositions including TKPP in Examples 4B, 4C, and 4D was observed to increase the removal rate from a normalized value of 152 to normalized values of 178, 179, and 155 while simultaneously reducing the surface waviness from a normalized value of 120 to normalized values of 109, 110, and 115. In Examples 4A and 4E the addition of DDBS and PVSA to compositions including TKPP was also observed to improve removal rate and waviness. In Example 4A the removal rate remained about the same (normalized values of 153 vs 152) and the surface waviness was reduced from a normalized value of 120 to 105, while in Example 4E, the removal rate was improved from a normalized value of 138 to 144 and the surface waviness was reduced from a normalized value of 115 to 110. The combination of a non-sulfonate compound (DEQUEST® P9200) with TKPP was observed to reduce surface waviness from a normalized value of 120 to 108 at the expense of reducing the removal rate from a normalized value of 152 to 120 (4F).

### Example 5

This example demonstrates the synergistic combination of a pyrophosphate compound and a quaternary amine compound in the disclosed polishing compositions. Each polishing composition included 8.5 weight percent colloidal silica having a mean particle size of 30 nm and sufficient nitric acid to adjust the pH to 1.8 (except for compositions 5H and 5I which had sufficient nitric acid to adjust the pH to values of 2.3 and 2.8). Polishing compositions 1A and 1G were as described above in Example 1. Compositions 5B-5I further included TKPP while compositions 5A-5I further included tetraethylammonium hydroxide at the amounts listed in Table 5 (all amounts in weight percent).

Six separate glass disks (substrates) were polished using each composition using a Hamai 9B double sided polishing tool at the polishing conditions described above in Example 1. The polishing rate and surface waviness HMS_Wq were also determined as described above for Example 1. Removal rate and surface waviness results are reported in Table 5. The results are normalized with respect to the removal rate and surface waviness achieved using polishing composition 1A reported in Table 1.

TABLE 5

| Polishing Composition | Phosphate Compound | Quaternary Amine | pH | Removal Rate | Surface Waviness |
|---|---|---|---|---|---|
| 1A | NA | NA | 1.8 | 100 | 100 |
| 1G | TKPP (0.12%) | NA | 1.8 | 152 | 120 |
| 5A | NA | TEAH (0.05 wt%) | 1.8 | 82 | 88 |
| 5B | TKPP (0.12%) | TEAH (0.02 wt%) | 1.8 | 168 | 152 |
| 5C | TKPP (0.12%) | TEAH (0.05 wt%) | 1.8 | 206 | 165 |
| 5D | TKPP (0.12%) | TEAH (0.1 wt%) | 1.8 | 211 | 165 |
| 5E | TKPP (0.12%) | TEAH (0.2 wt%) | 1.8 | 207 | 160 |
| 5F | TKPP (0.06%) | TEAH (0.05 wt%) | 1.8 | 205 | 160 |
| 5G | TKPP (0.03%) | TEAH (0.05 wt%) | 1.8 | 207 | 152 |
| 5H | TKPP (0.03%) | TEAH (0.05 wt%) | 2.3 | 207 | 132 |
| 5I | TKPP (0.03%) | TEAH (0.05 wt%) | 2.8 | 190 | 125 |

As set forth in Table 5, the addition of the quaternary amine compound (5A) (in the absence of TKPP) was observed to improve surface waviness at the expense of reducing the removal rate (waviness was reduced to a normalized value of 88 at the expense of decreasing the removal rate to a normalized value of 82). As described above in Example 1, the addition of pyrophosphate (1G) was observed to increase the removal rate at the expense of increasing the surface waviness (removal rate was increased to a normalized value of 152 while the waviness also increased to a normalized value of 120). An unexpected synergistic interaction was observed for compositions 5B, 5C, 5D, 5E, 5F, and 5G in which the addition of the quaternary amine (TEAH in this example) to the polishing composition including the pyrophosphate compound significantly improved the removal rate. Compared to composition 1G, these compositions achieved increased removal rates having normalized values of 168, 206, 211, 207, 205, and 207. Note in particular that compositions 5F and 5G including lower amounts of TKPP (0.06 and 0.03 weight percent) achieved very high removal rates having normalized values of 205 and 207 (as compared to compositions 1D and 1F in Example 1 that included TKPP amounts of 0.02 and 0.08 weight percent). Compositions 5H and 5I demonstrate that increasing the pH to 2.3 and 2.8 decreased the surface waviness (to normalized values of 132 and 125) without significantly decreasing the removal rate (achieving normalized removal rates of 207 and 190).

### Example 6

This example demonstrates that the above described synergistic effect was observed using other quaternary amines (in addition to TEAH) in the polishing composition. As described above for Example 5, each polishing composition included 8.5 weight percent colloidal silica having a mean particles size of 30 nm and sufficient nitric acid to adjust the pH to 1.8. Polishing compositions 1E and 1G were as described above in Example 1. Compositions 6A, 6B, and 6C further included TKPP at the amounts listed in Table 6 (all amounts in weight percent). Compositions 6A and 6B included alternative quaternary amines at the amounts listed (benzyltributylammonium chloride and tetrabutylammonium hydroxide). Composition 6C included epsilon polylysine (a non-quaternary amine cationic compound).

Six separate glass disks (substrates) were polished using each composition using a Hamai 9B double sided polishing tool at the polishing conditions described above in Example 1. The polishing rate and surface waviness HMS_Wq were also determined as described above for Example 1. Removal rate and surface waviness results are reported in Table 6. The results are normalized with respect to the removal rate and surface waviness achieved using polishing composition 1A reported in Table 1.

TABLE 6

| Polishing Composition | Phosphate Compound | Cationic Compound | Removal Rate | Surface Waviness |
|---|---|---|---|---|
| 1E | TKPP (0.03%) | NA | 130 | 115 |
| 1G | TKPP (0.12%) | NA | 152 | 120 |
| 6A | TKPP (0.12%) | Benzyltributylammonium chloride (0.03 %) | 186 | 153 |
| 6B | TKPP (0.12%) | TBAH (0.03%) | 185 | 152 |
| 6C | TKPP (0.03%) | EPL (ε-polylysine) (0.005%) | 105 | 117 |

As set forth in Table 6, the synergistic effect observed above in Example 5 is observed for other quaternary amines (in addition to TEAH). Note that compositions 6A and 6B achieved very high removal rates (normalized values of 186 and 185) as compared to composition 1G (similar to compositions 5B and 5C in Example 5). No synergism was observed for composition 5C (a non-quaternary ammonium compound), which was observed to have a lower removal rate than composition 1E (a normalized value of 105 versus 130) and a similar surface waviness.

It will be understood that the recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A chemical mechanical polishing composition comprising:
a liquid carrier;
abrasive particles in the liquid carrier;
a pyrophosphate compound; and
a sulfonate compound including a sulfonate anionic surfactant or an anionic polymer including sulfonic acid groups.

2. The composition of claim 1, wherein the abrasive particles comprise colloidal silica particles.

3. The composition of claim 1, wherein the abrasive particles have a mean particle size in a range from about 15 nm to about 40 nm.

4. The composition of claim 1, comprising from about 5 weight percent to about 15 weight percent of the abrasive particles at point of use.

5. The composition of claim 1, wherein the pyrophosphate compound comprises tetrapotassium pyrophosphate (TKPP) or tetrasodium pyrophosphate (TSPP).

6. The composition of claim 1 comprising:
from about 0.01 weight percent to about 0.2 weight percent of the pyrophosphate compound at point of use; and
from about 0.01 weight percent to about 0.2 weight percent of the sulfonate compound at point of use.

7. The composition of claim 6, wherein the sulfonate compound comprises a disulfonate anionic surfactant.

8. The composition of claim 7, wherein sulfonate compound comprises an alkyldiphenyloxide disulfonate anionic surfactant.

9. The composition of claim 1 having a pH in a range from about 1.5 to about 3.

10. The composition of claim 1, further comprising an anionic polymer.

11. The composition of claim 10, wherein the anionic polymer is a polyacrylate or a polymethacrylate polymer.

12. A chemical mechanical polishing composition comprising:
a liquid carrier;
abrasive particles in the liquid carrier;
a pyrophosphate compound;
a compound including a quaternary ammonium group.

13. The composition of claim 12 comprising:
from about 0.01 weight percent to about 0.2 weight percent of the pyrophosphate compound at point of use; and
from about 0.01 weight percent to about 0.2 weight percent of the compound including the quaternary ammonium group at point of use.

14. The composition of claim 12, wherein the abrasive particles comprise colloidal silica particles.

15. The composition of claim 14, wherein the abrasive particles have a mean particle size in a range from about 15 nm to about 40 nm.

16. The composition of claim 14, comprising from about 5 weight percent to about 15 weight percent of the abrasive particles at point of use.

17. The composition of claim 12, wherein the pyrophosphate compound comprises tetrapotassium pyrophosphate (TKPP) or tetrasodium pyrophosphate (TSPP).

18. The composition of claim 12, wherein the compound including the quaternary ammonium group comprises a tetramethylammonium group, a tetraethylammonium group, a tetrabutylammonium group, a benzyltributylammonium group, or a mixture thereof.

19. The composition of claim 18, wherein compound including the quaternary ammonium group is tetraethylammonium hydroxide.

20. The composition of claim 12 having a pH in a range from about 1.5 to about 3.

21. A method for polishing a glass substrate, the method comprising:
(a) contacting the substrate with a polishing composition of claim 12;
(b) moving the polishing composition and a polishing pad relative to the substrate; and
(c) abrading the substrate to remove a portion of the substrate to polish a surface of the substrate.
